(19) United States
(12) Patent Application Publication
(10) Pub. No.: US 2026/0217050 A1
(43) Pub. Date: Jul. 30, 2026

(54) METHOD FOR MANUFACTURING A SECURITY DEVICE, SECURITY DEVICE OBTAINED BY SUCH A METHOD, AND IDENTITY DOCUMENT COMPRISING SUCH A DEVICE

(71) Applicant: IN Smart Identity France, Courbevoie (FR)

(72) Inventors: Marie MAZZOLINI, COURBEVOIE (FR); Coralie VANDROUX, COURBEVOIE (FR); Benoît BERTHE, COURBEVOIE (FR)

(21) Appl. No.: 19/458,038

(22) Filed: Jan. 23, 2026

(30) Foreign Application Priority Data
Jan. 24, 2025 (FR) 2500760

(51) Int. Cl. B42D 25/351; B42D 25/44

(52) U.S. Cl. CPC B42D 25/351; B42D 25/44

(57) ABSTRACT

A method for manufacturing a security device includes providing a transparent window including a front face, including an array of microlenses having a focal length “f”, and a rear face; defining a global image comprising at least two patterns configured to represent at least two images visible to an observer according to different angles of observation through the array; disposing the global image relative to the array; and engraving the global image through the rear face and between an engraving plane and the rear face, the engraving plane being located between the front face and the object focal plane of the microlenses and being distant from the rear face by a distance “d” less than or equal to one third of the focal length “f”. A security device and a document including the security device are obtained by such a method.

### TECHNICAL FIELD OF THE INVENTION

The invention relates to a method for manufacturing a security device, in particular a security device comprising a window provided with a lenticular array through which at least one image is visible according to a predefined angle of observation.

It also relates to a security device obtained by such a method, as well as an identity document comprising such a device.

The window of such a security device can constitute just a part of the security device, or the security device can consist entirely of such a window.

### PRIOR ART

Personalizing a window with a lenticular array to obtain a three-dimensional (3D) effect or an animation is usually carried out via a side of the lenses of the lenticular array, and conventionally by laser engraving through the lenticular array.

However, there is a growing need to produce more and more images under a lenticular array, for example to create CLI/MI images (involving 2 or 3 images), SLI images (usually 4 images), or images combining linear patterns and laser engraving technology (involving for example 7 or 14 images).

Each image is for example engraved according to an angle that is specific to it, generally via a laser beam.

For each angle, the window is inclined by this angle relative to the laser beam to engrave the corresponding image.

Each image takes several tenths of a second to engrave.

Thus, for example, to engrave fifteen images, thus at fifteen different angles, it takes fifteen movements each taking approximately half a second and after each movement, several tenths of a second to engrave the corresponding image.

For a given window, there is therefore a compromise to be made between the desired quality of visual effects and the time to produce all the desired images, which affects the cost of personalization.

For example, for an image combining linear patterns and a laser engraving technology that preferably comprises seven images, for an angular amplitude of approximately −6° to +6°, it can be chosen to restrict the number of images to the four images of a conventional SLI, which therefore reduces a quality of the visual appearance.

Another disadvantage of engraving through lenses involving inclining the window relative to the laser is that a laser, which is equipped with a galvanometric head provided with an F-theta lens to deflect the beam of the laser and thus reach various points of a marking field, is designed to focus the laser beam according to a plane perpendicular to the axis of symmetry of the F-theta lens of the galvanometric head. However, when the surface of the window is no longer perpendicular to this axis, the focusing is no longer ensured and the images can therefore lose sharpness.

In addition, the images engraved in the window are conventionally engraved at a short distance from the array of lenses. Indeed, the laser beam used to engrave the images is focused behind the lenses by traveling a short distance in the window.

One disadvantage of the structure thus obtained is that an observer must carry out a rotation of several degrees to observe the desired animation.

It was then proposed to engrave via the rear face of a window comprising the lenticular array on the front face.

However, by engraving the images in the window via a rear face, that is to say via the face opposite to the lenticular array, to engrave the image in the window at a distance relatively close to the array of microlenses, the laser beam must first pass through a greater thickness of material in the window to reach the same distance relative to the front face, i.e. relative to the lenticular array. The sensitive areas between the rear face and the engraving plane are thus also engraved, i.e. affected by the laser.

Consequently, an overlap of the various engraved areas can be observed, which means visual interference and incidentally a decrease in the observed image quality. The present invention aims to at least partly overcome the aforementioned disadvantages, while further leading to other advantages.

### DISCLOSURE OF THE INVENTION

To this end, according to a first aspect, a method for manufacturing a security device is proposed, the security device comprising at least a first image visible through an array of microlenses to an observer according to a first angle of observation and a second image visible through the array of microlenses to the observer according to a second angle of observation, the second angle of observation being different from the first angle of observation, the method comprising the following steps:
A step of providing a window that is transparent to at least a part of visible light, the window comprising a front face and a rear face, the front face comprising an array of microlenses, each microlens of the array of microlenses having a focal length “f” defining an object focal plane parallel to the front face and to the rear face of the window;
A step of defining a global image comprising at least two patterns, the at least two patterns being configured to represent the first image visible to the observer according to the first angle of observation through the array of microlenses and the second image visible to the observer according to the second angle of observation through the array of microlenses;
A step of disposing the global image relative to the array of microlenses; and
A step of engraving of the global image through the rear face and between an engraving plane and the rear face of the window by a laser beam incident on the rear face, the engraving plane being located between the front face of the window and the object focal plane of the microlenses and being distant from the rear face of the window by a distance “d”, the distance “d” being less than or equal to one third of the focal length “f”, and the laser forming an engraving point according to an optical axis Δ, the optical axis Δ forming an angle of incidence a with the rear face of the window.

The engraved global image consists of the multiple patterns required to produce the desired visual effect, for example to create a 3D-effect image or an animation.

Each pattern is cut up into as many sub-patterns as there are microlenses.

The global image is engraved in one go, at the same angle of incidence a of the laser beam relative to the rear face, and via the rear face of the window, i.e. on the side opposite to that of the microlenses.

By engraving via the rear face, the gain in personalization time is all the more considerable because there are numerous patterns to engrave.

For example, the window is disposed perpendicularly to the optical axis to ensure the best possible focus in the engraving plane.

The expression “engraving plane” is understood in the present document as the upper tangent plane of the engraved image, that is to say the tangent plane of the engraved image closest to the front face comprising the array of microlenses.

The engraving plane is located close to the rear face of the window.

“Close” here means a distance of less than a third, preferably a quarter, of the thickness of the window.

Here, engraving via the rear face allows to engrave the global image in the engraving plane by passing through a relatively limited thickness of material in the window, thus allowing to limit interference.

Furthermore, in comparison to a method of the prior art, the optical path traveled by the light between the engraving plane and the array of microlenses is greater. The angular size of a sub-pattern of the global image is thus smaller than for a device of the prior art.

In other words, the observer switches from a first image visible according to a first angle of observation to a second consecutive image visible according to a second angle of observation by carrying out a variation in angle of inclination smaller than in a method of the prior art.

In addition, each image observed from a given angle of observation appears sharper. For example, the pattern of the global image can be a frame. Here, the global image comprises an interlacing of at least two frames. Each image observable according to a given angle of observation is first compressed by the magnification factor of the microlenses in a direction, then cut into as many strips of frames as there are microlenses. The strips of frames form the sub-patterns of the global image. Then all the frames of all the images are interlaced so that this assembled image, i.e. the global image, covers the surface opposite the lenticular area, that is to say here the rear face of the window, under the array of microlenses.

For example, the pattern of the global image can be an array of samples of images of an array of periodic images. The global image here comprises at least one array of images having a period T1. The period T1 can be different from a period of the array of microlenses. Each lens of the lenticular array thus magnifies a different sample of the image of the periodic image array, and the global image is observed through the array of microlenses. The samples magnified by each of the microlenses form the sub-patterns of the global image.

For example, a sub-pattern of the global image can have an angular size through the array of microlenses less than or equal to 5 degrees, or even less than or equal to 2 degrees.

For example, to promote a sharpness of the observable image, the focal length of a lens of the array of microlenses is chosen to be greater than in a method of the prior art.

A pitch of the array of microlenses can therefore for example be increased.

Consequently, more patterns can be engraved under the array of microlenses.

This facilitates the creation of sophisticated effects requiring a large number of images for a given angular range of observation.

Indeed, in a method according to the prior art, large amplitudes, by the method of relative inclination with engraving through the array of microlenses, are impossible to achieve, or at least very difficult, since the engraving point is then too far from the focal plane of the F-theta lens.

In an exemplary embodiment, the angle of incidence a is between 80° and 100° relative to the rear face of the window, for example equal to 90°.

An angle of incidence a perpendicular to the rear face allows for example to have optimized focusing of the laser beam.

To do this, a laser engraving device comprises for example an F-Theta lens mounted on a galvanometric head, as described below.

In an exemplary embodiment, the step of providing a window is configured so that the focal length of the microlenses of the array of microlenses is greater than or equal to 600 μm.

For example, the focal length of each microlens of the array of microlenses of the window can be chosen so that the object focal plane is located between the engraving plane and the rear face of the lens.

For example, the step of engraving the global image is configured to form an engraved image with a predetermined thickness.

The engraving point has an engraving depth, taken according to a thickness of the window.

By definition, the engraving depth extends from the engraving plane, in the direction of the rear face.

According to an exemplary embodiment, the engraving depth is at least equal to 50 μm.

According to an exemplary embodiment, the engraving depth is at most equal to the distance d, or even 200 μm, preferably 150 μm.

According to an exemplary embodiment, the engraving depth can extend over at least two layers of the window.

According to an exemplary embodiment of interest, the focal plane of the microlenses is located in the thickness of the engraving points.

In an exemplary embodiment, the step of engraving the global image is configured to produce the engraving point having a diameter at most equal to half a width of a sub-pattern of the image.

For example, the laser has a dot size sufficiently small to be able to engrave each pattern with at least two dots per sub-pattern width. This allows to better control the level of engraving than if a single dot covered the width of a sub-pattern since two dots are statistically much less sensitive to disturbances than a single dot. For example, with a 10 μm laser dot to produce 14 patterns with two dots per width of sub-patterns, the lenses have for example a pitch of 280 μm.

For example, the step of engraving the global image comprises the engraving of at least one pattern with at least two dots per sub-pattern width.

In an exemplary embodiment, the laser is an ultraviolet radiation laser.

Here, ultraviolet laser radiation means laser radiation having a wavelength less than or equal to 380 nm, for example between 300 nm and 380 nm.

In an exemplary embodiment, the laser is a YAG laser that emits at a wavelength of 1064 nm.

In an exemplary embodiment, the laser is a CO₂ laser that emits at a wavelength of approximately 10640 nm.

However, there is a relationship between engraving dot size and wavelength. To place as many patterns as possible under a microlens, a UV laser is of interest since it allows to produce a dot diameter smaller than that of an infrared laser for example.

In an exemplary embodiment, the engraving step is configured to form the global image at a distance of less than 200 μm, preferably 150 μm, for example between 0 μm and 200 μm, preferably between 0 μm and 150 μm, relative to the rear face of the window.

In an exemplary embodiment, the step of engraving the global image is configured so that the width of a sub-pattern of the global image corresponds to a difference in angles of observation through the array of microlenses less than or equal to 5°, or even less than or equal to 2°.

Since the angular size of a sub-pattern of the global image is smaller than for an array of microlenses of the prior art, the first angle of observation of the first image observable through the array of microlenses can be closer to the second angle of observation of the second image observable through the array of microlenses, given that the first image and the second image are consecutive images, i.e. the second image is the image directly observable by changing the angle after observation of the first image considered.

For example, the difference between the first angle of observation of the first image visible through an array of microlenses to an observer and the second angle of observation of the second image visible through the array of microlenses to the observer is less than or equal to 5°, or even less than or equal to 2°.

For example, the contrast between the various images observable according to different angles of observation is improved with respect to a method of the prior art.

For example, when the observer varies the angle of observation, they scan through the various images observable at different angles of observation faster than in a method of the prior art.

Here, a scanning speed designates the perception by the observer of a more or less rapid passage from a first image to a second consecutive image.

In the context of the invention, a scanning speed is defined as being the variation in angle corresponding to the passage from the observation of a first image to the observation of a second consecutive image. Indeed, if the angle variation required to change the observed image decreases, the observer will have the perception of a faster change than if a larger angle is required to observe the same two images consecutively.

In an exemplary embodiment, the method comprises a step of frosting the rear face, the frosted rear face being configured to scatter at least a part of the visible light.

For example, the frosted rear face has a predefined roughness Ra between 360 and 500 nm.

A frosting carried out on the side opposite to the lenses allows to limit a risk of disturbing the observation of the image due to a background environment that would be visible when looking through the window, in this case on the side of the microlenses. This frosting scatters visible light.

Here, visible light designates a light spectrum having a wavelength between approximately 380 nm and 780 nm.

In an exemplary embodiment, the step of disposing the global image relative to the array of microlenses comprises:
A step of disposing a source of lighting on one side of the window and a step of disposing a camera on the same side or on an opposite side of the window;
A step of lighting of the array of microlenses by the source of lighting;
A step of reception, by the camera, of a light beam having interfered with the window;
A step of determining an arrangement of the array of microlenses from the light beam received by the camera; and
A step of redefining the global image with respect to the determined arrangement of the array of microlenses.

This exemplary embodiment is particularly useful when the patterns of the global image are interlaced frames.

In one exemplary embodiment, the source of lighting and the camera can for example be disposed on the same side of the window, for example on the microlenses side or on the rear face side.

If applicable, micro-singularities are preferably introduced into the lenticular array. The micro-singularities comprise for example small flat areas. Insofar as these micro-singularities are created at the same time as the lenticular array, their actual positions, i.e. their deviations from their theoretical positions, allow to deduce that at these locations, the lenticular array is offset by the same deviations. An interpolation between these points allows to determine where the actual lenticular array is located.

In another exemplary embodiment, the source of lighting and the camera can be disposed on either side of the window.

For example, the step of disposing the global image relative to the array of microlenses then comprises:
A step of disposing a source of lighting on a front side of the window and a step of disposing a camera on a rear side of the window, the array of microlenses formed on the front face of the window being disposed between the source of lighting and the rear face, and the rear face being disposed between the array of microlenses formed on the front face and the camera;
A step of lighting of the array of microlenses by the source of lighting;
A step of reception, by the camera, of a light beam having passed through the window;
A step of determining an arrangement of the array of microlenses from the light beam received by the camera; and
A step of redefining the global image with respect to the arrangement of the array of microlenses.

The precise real arrangement of each microlens, i.e. its position and its shape, in particular its width, can thus be identified and allows to adapt each pattern, or even each sub-pattern, to each microlens.

The tolerance of arrangement of the microlenses on the front face is strict (approximately one micrometer) and a pitch of the microlenses can vary by several microns.

The adjustment of the patterns with respect to the microlenses is preferably as precise as possible, or in practice from 1 μm to 3 μm.

The best possible adaptation of the patterns with respect to the reality of the microlenses, for each window, allows to promote a better quality of the images, that is to say better rendering.

In an exemplary embodiment, the source of lighting provides a collimated spectrum.

In an exemplary embodiment, the source of lighting provides a spectrum of ultraviolet radiation.

In an exemplary embodiment, the source of lighting comprises a UV diode.

In an exemplary embodiment, the camera comprises a camera sensitive to UV radiation.

In an exemplary embodiment, the method can comprise a step of creating at least one singular point configured to serve as a marker for the global image.

For example, the at least one singular point can be created via a lamination plate which, at certain locations of the array of microlenses, imposes a singularity such as a micro flat area recognizable in image processing. Thus, these marks are used as reference points from which the exact position of the lenses are deduced.

It can be of interest for the personalization, that is to say the engraving of the global image in the window, to occur when the security device is integrated into at least part of an identity document.

The at least one part of an identity document can for example consist of several layers assembled with each other by lamination.

For example, the method comprises an additional step of integrating the device into at least a part of the identity document, before the step of engraving the global image in the engraving plane.

According to a second aspect, a security device obtained by a method as described above is also proposed.

For example, the device comprises:
a window that is transparent to at least a part of visible light, the window comprising a front face and a rear face, the front face comprising an array of microlenses, each of the microlenses having a focal length “f” defining an object focal plane parallel to the front face and to the rear face of the window;
a global image, engraved in the window in an engraving plane, the global image comprising at least two patterns, the at least two patterns being configured to form a first image visible to an observer according to a first angle of observation through the array of microlenses, and a second image visible to the observer according to a second angle of observation through the array of microlenses, the second angle of observation being different from the first angle of observation, and the engraving plane of the global image being located between the front face of the window and the object focal plane of the microlenses and being distant from the rear face of the window by a distance “d”, the distance “d” being less than or equal to one third of the focal length “f” of the microlenses.

In an exemplary embodiment, the microlenses of the array of microlenses of the window have a focal length greater than or equal to 600 μm.

In an exemplary embodiment, the array of microlenses of the window has a pitch greater than or equal to 100 μm.

In one embodiment, the array of microlenses of the window has a pitch less than or equal to 400 μm.

The security device has features and advantages analogous to those related to the method described above.

According to a third aspect, an identity document comprising a security device as described above is also proposed.

For example, the identity document is an identity card, a passport, a bank card, an identification card (of the access badge type) or a loyalty card, or other.

### BRIEF DESCRIPTION OF THE DRAWINGS

The invention, according to an exemplary embodiment, will be understood clearly and its advantages will become more apparent upon reading the following detailed description, given for informational and in no way limiting purposes, in reference to the appended drawings in which:

FIG. 1 schematically shows an example of a security device window provided with an array of microlenses on the front face;

FIG. 2 shows an example of six frames, forming six images, used as a basis for the definition of a global image;

FIG. 3 shows the device of FIG. 1 comprising a frosting formed on the rear face;

FIG. 4 shows the device of FIG. 1 or 3 in the window of which a global image is engraved on the rear face;

FIG. 5 shows a block diagram schematizing a method according to an embodiment of the invention;

FIG. 6 shows an identity document comprising a security device according to an exemplary embodiment;

FIG. 7 schematically illustrates a cross-sectional view of a device of the prior art;

FIG. 8 shows a variation in light intensity observed with a device according to FIG. 7;

FIG. 9 schematically illustrates a cross-sectional view of a device according to an exemplary embodiment of the invention;

FIG. 10 shows a variation in light intensity observed with a device according to FIG. 9;

FIG. 11 schematically shows a device according to another exemplary embodiment of the invention;

FIG. 12 shows images that can be obtained by the method according to an exemplary embodiment of the invention;

FIG. 13 shows an example of an array of images configured to form at least two images observable at different angles of observation.

### DETAILED DESCRIPTION

The invention according to an exemplary embodiment aims to provide a method for manufacturing a security device comprising at least a first image visible to an observer according to a first angle of observation, and a second image visible to the observer according to a second angle of observation, the second angle of observation being different from the first angle of observation.

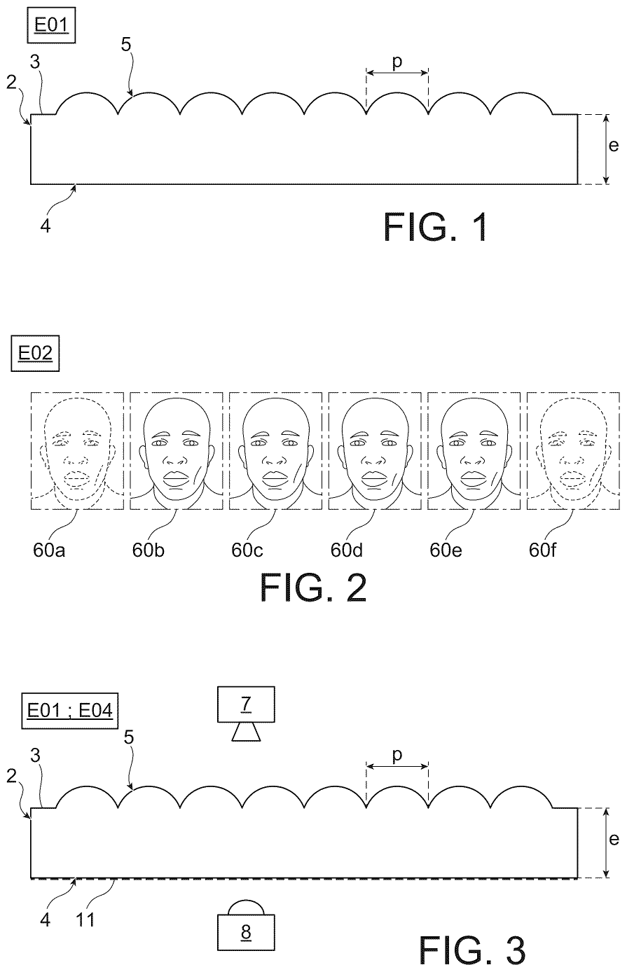

For this, the method, according to an exemplary embodiment, comprises a step E01 of providing a window 2 of a security device 1, for example as schematized in FIG. 1.

FIG. 1 shows a window 2 of a security device 1 according to an exemplary embodiment.

The window 2 is transparent to at least a part of visible light.

In other words, it transmits at least 10%, or even 50%, or even 90%, or even 95% of a spectrum of visible light passing through it.

Here, visible light designates a light spectrum having a wavelength between approximately 380 nm and 780 nm.

The window 2 comprises a front face 3 and a rear face 4 which are substantially parallel to one another and define between them a thickness noted as “e”.

The window 2 further comprises an array of microlenses 5, also referred to as a lenticular array, which is formed, by definition here, on the front face 3.

The microlenses 5 are all shown as identical here. They are for example cylindrical or spherical.

Each microlens 5 has a focal length “f”.

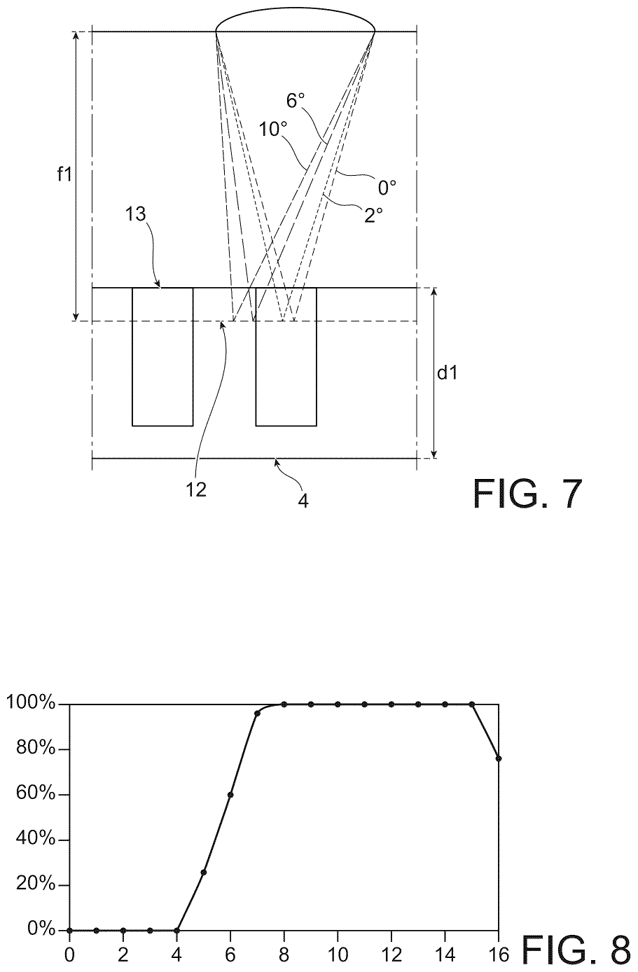

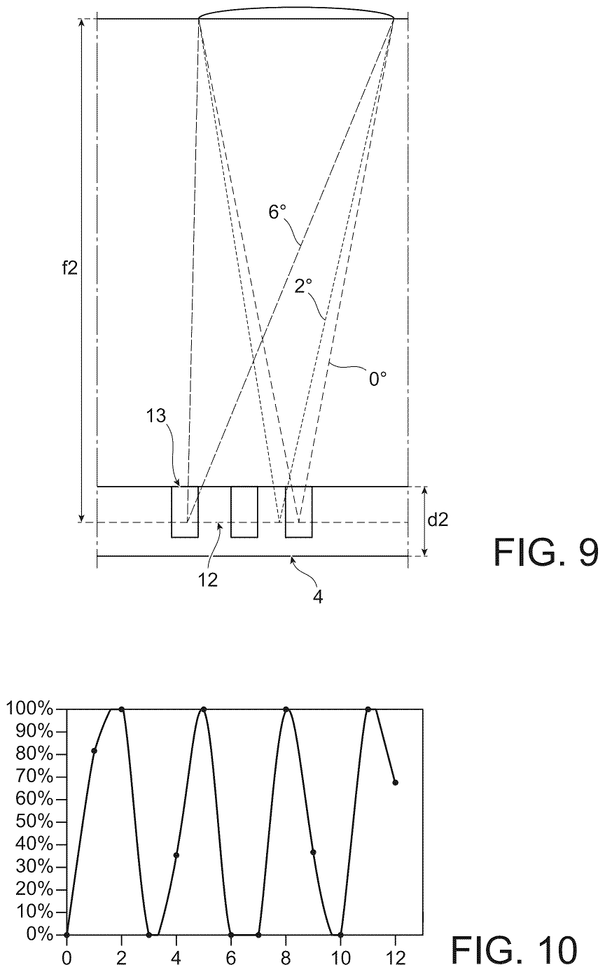

The focal length “f” defines an object focal plane 12 (illustrated in FIGS. 7 and 9 for example) parallel to the front face 3 and to the rear face 4 of the window 2.

Here, this focal length is theoretically the same for all the microlenses of the array of microlenses 5. However, in practice, this distance can vary, within a zone of tolerance, from one lens to another.

In the example of representation of FIG. 1, each microlens 5 has a width “p”, also referred to as “p”.

This width is theoretically the same for all the microlenses of an array of microlenses. However, in practice, this width can vary, within a zone of tolerance, from one lens to another.

In order to produce a visual effect, for example a 3D image or an animation, at least two images are formed under the array of microlenses.

Each image observed through the array of microlenses is the combination of a series of patterns, at least two sub-patterns being formed under each of the microlenses.

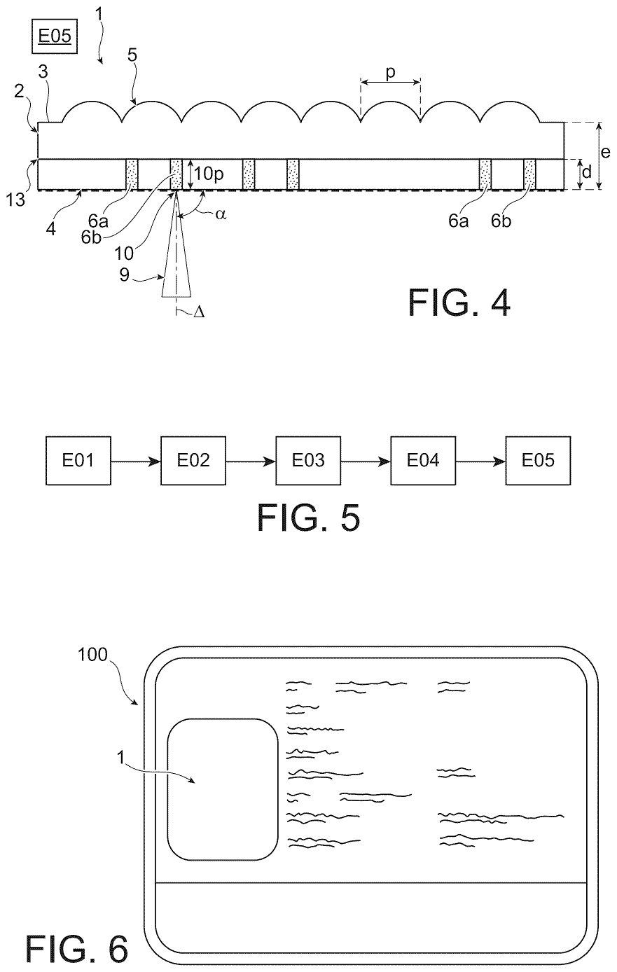

As illustrated in FIG. 4 for example, a sub-pattern 6a of a first image and a sub-pattern 6b of a second image are engraved under the same microlens.

The global image is thus configured to represent various images visible to an observer according to various angles of observation, which are each specific to the corresponding image, through the array of microlenses.

For purely illustrative purposes, FIG. 2 presents a complex case in which a visual effect is created from six images 60 (labelled 60a to 60f) allowing, for example here, to create a 3D portrait, the head of the portrait of which rotates according to an angle of observation.

In the prior art, regardless of the number of images, each image is generally engraved in the window through the array of microlenses at an angle specific to it, generally via a laser beam.

For each angle, the window is inclined by this angle relative to the laser beam to engrave the corresponding image.

Each image takes several tenths of a second to engrave.

The invention according to an exemplary embodiment proposes in particular a step E02 of defining a global image comprising all the frames to be engraved that are interlaced.

In the present example, the global image would comprise the six interlaced frames.

Once the global image has been defined, the method according to an exemplary embodiment can then comprise:
A step E04 of disposing the global image relative to the array of microlenses; and
A step E05 of engraving the global image in an engraving plane of the window.

The expression “engraving plane” is understood in the present document as the upper tangent plane of the engraved image, that is to say the tangent plane of the engraved image closest to the front face comprising the array of microlenses.

According to a feature of interest, the engraving point has an engraving depth, taken according to a thickness of the window.

By definition here, the engraving depth extends from the engraving plane, in the direction of the rear face.

In an exemplary embodiment, illustrated for example in FIG. 3, the step E04 of disposing the global image relative to the array of microlenses comprises for example sub-steps as follows:
A step of disposing a source of lighting 7 on a front side of the window 2 and a step of disposing a camera 8 on a rear side of the window 2, the array of microlenses 5 of the front face 3 of the window 2 being disposed between the source of lighting 7 and the rear face 4, and the rear face 4 being disposed between the array of microlenses 5 of the front face 3 and the camera 8;
A step of lighting of the array of microlenses 5 by the source of lighting 7;
A step of reception, by the camera 8, of a light beam having passed through the window 2;
A step of determining an arrangement of the array of microlenses 5 from the light beam received by the camera 8; and
A step of redefining the global image with respect to the arrangement of the array of microlenses 5.

According to a feature of interest, the engraving point 10 has an engraving depth 10p (illustrated in FIG. 4), taken according to a thickness of the window 2.

By definition here, the engraving depth 10p extends between the engraving plane 13, in the direction of the rear face 4.

According to an alternative not shown, the camera and the source of lighting can however be disposed on the same side of the window, and the processing of the image received by the camera is adapted.

The precise real arrangement of each microlens, i.e. its position and its shape, in particular its width p and its focal length f, can thus be identified and allows to adapt each frame, or even each frame strip, to each microlens 5.

In an exemplary embodiment, the source of lighting 7 provides a collimated spectrum of ultraviolet radiation.

In an exemplary embodiment, the camera 8 comprises a camera sensitive to UV radiation.

According to one embodiment of the invention, as illustrated in FIG. 4 in particular, the engraving step E05 is implemented in the engraving plane 13 and through the rear face 4, here by a laser beam 9 with ultraviolet radiation, incident on the rear face 4.

The engraving plane 13 is located between the front face 3 of the window and the object focal plane 12 of the microlenses 5. The engraving plane 13 is distant from the rear face 4 of the window 2 by a distance d. The distance d is less than or equal to a third, or even a quarter, of the focal length f.

For example, the distance d is between 50 μm and 200 μm, or even 50 μm and 150 μm.

For example, the laser 9 forms an engraving point 10 according to an optical axis Δ, which has an engraving depth 10p extending from the engraving plane 13, in the direction of the rear face 4.

According to a feature of interest, the engraving point 10 has a diameter, or width, at most equal to half a width of a strip of one of the frames of the image.

According to a feature of interest, the engraving point 10 has an engraving depth 10p, taken according to a thickness of the window 2.

By definition here, the engraving depth 10p extends from the engraving plane 13, in the direction of the rear face 4.

According to one embodiment, the engraving depth 10p is at least equal to 50 μm.

According to one embodiment, the engraving depth 10p is at most equal to the distance d, or even 200 μm, preferably 150 μm.

The optical axis Δ forms an angle of incidence a with the rear face 4 of the window 2.

The angle of incidence a is preferably between 80° and 100° with respect to the rear face 4 of the window 2. In the present exemplary embodiment, the angle of incidence a is equal to 90°. In other words, the laser engraves perpendicularly to the rear face 4. This has the advantage of obtaining optimized focusing in the entire engraving plane.

In a purely illustrative example, FIG. 13 shows an array of images 14 configured to form at least two images 15a,15b observable at different angles of observation. The global image here comprises at least one array of images 14 having a period T1. The period T1 can be different from the pitch “p” of the array of microlenses 5. Each lens of the lenticular array thus magnifies a different sampling of the image 14 of the array of periodic images, and the global image 15a,15b is observed through the array of microlenses 5. According to whether the observer inclines the window according to a first angle (angle 1) or a second angle (angle 2), the visible portion of the image 14 of the periodic array of images is not the same, and the observer then sees either the image 15a or the image 15b, and by going from the first angle to the second angle, they then perceive an effect of motion, in this case of movement of the letter “A”, for example here from left to right.

FIGS. 3 and 4 illustrate an option of interest, according to which the rear face 4 comprises a frosting 11.

Such a frosting 11 is for example formed during a step E03 of frosting the rear face 4.

For example, the defined roughness is pre-made on a lamination back plate and is then replicated in the window.

The frosted rear face thus has a predefined roughness Ra to scatter at least a part of visible light.

For example, the roughness Ra of the frosted rear face 4 has a value between 360 nm and 500 nm.

A frosting 11 on the rear face 4 allows an observer to see the global image sufficiently distinctly once engraved in the window by limiting a risk of disturbance of the observation of the global image due to a background environment that would be visible when looking through the window 2.

This can be the case if the security device is integrated into a passport in which a page following that in which the security device is disposed comprises information that could visually interfere. Or this can be the case for an identity card or a card of the bank card type, or any other card, when they are disposed on any given support, possibly non-uniform.

The personalization carried out via the back of the window must however retain its precision as much as possible despite the frosting.

The frosting is thus possibly determined according to the engraving wavelength of the laser beam 9 used, and vice versa.

For example, the roughness (Ra) has a value of approximately 400 nm for UV radiation of approximately 355 nm since such UV radiation will thus not be scattered, which allows a sufficiently precise engraving of the global image through the frosted rear face.

For example, in practice, the method can comprise a step of determining the roughness according to the engraving radiation, for example comprising sub-steps as follows:
A Nyquist test step, in which a Nyquist test is implemented, with a black/white alternation of bars according to a series of bars, a width of which decreases to approximately 10 μm for example; the bars being engraved via the back of a window; the black/white alternation respecting a predefined visibility criterion;
A step of verifying that the visible spectrum is scattered according to a predefined scattering criterion, by observing a scene through the frosting; the scene should appear with a blur according to a predefined blur criterion, and the blur can be quantified by placing RGB Nyquist tests at a predefined distance from the frosting, and by verifying that between a configuration without frosting and a configuration with frosting, several blur harmonics are lost.

For example, without frosting, a pair of bars is observed while with frosting, the pair is no longer visible, nor a double-pitch pair, nor even a triple-pitch pair.

In the present exemplary embodiment, the frosting step E03 is implemented before the step of engraving the global image in the window 2.

Consequently, the step of engraving the global image in the window 2 is implemented through the rear face 4 with the frosting 11.

Thus, FIG. 4 illustrates a security device 1 according to an exemplary embodiment, comprising:
The window 2, the rear face 4 of which is frosted and has a predefined roughness Ra configured to scatter at least a part of visible light,
The global image, engraved in the window 2, comprising at least two patterns (6a,6b).

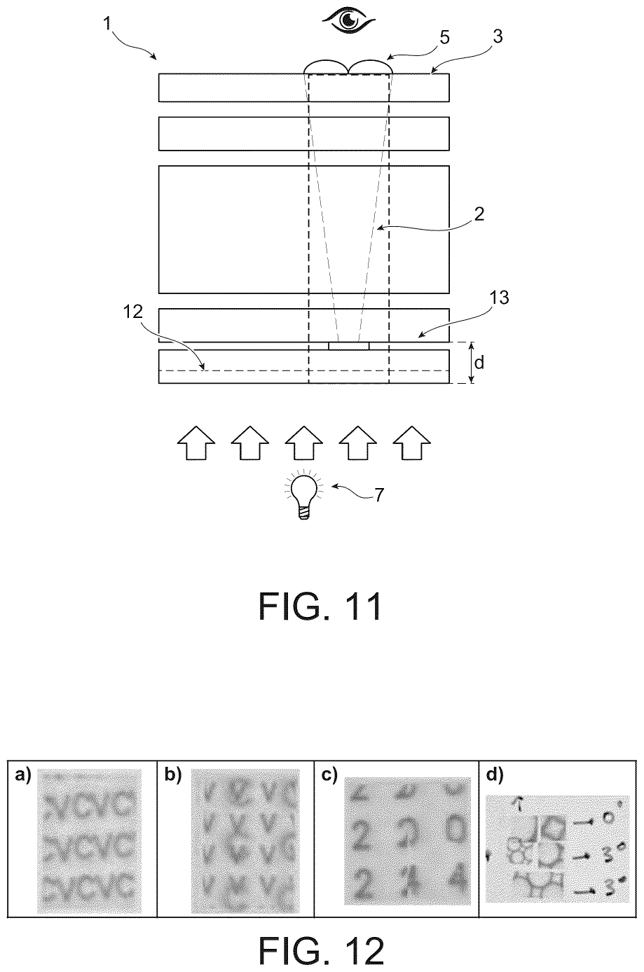

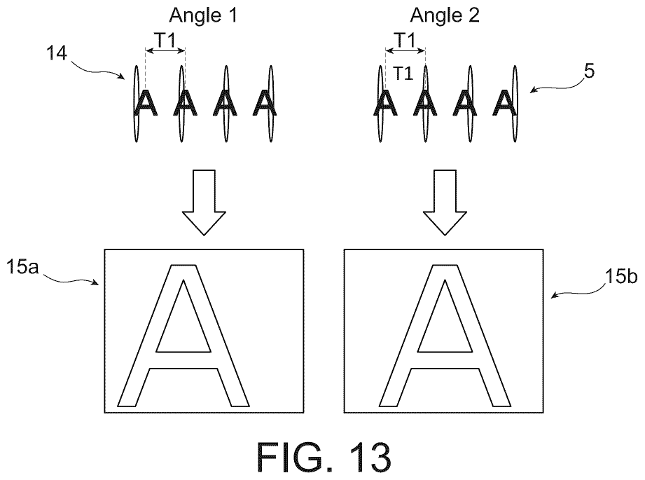

FIG. 11 is another cross-sectional representation of the device according to an exemplary embodiment of the invention.

In this exemplary embodiment, the device 1 comprises several layers according to its thickness.

Consequently, the window 2 is itself formed, according to its thickness, by a stack of these layers.

Here, the engraving plane 13 is located between the front face 3 of the window 2 and the object focal plane 12 of the microlenses and is distant from the rear face 4 of the window 2 by the distance d, the distance d being less than or equal to a third, or even a quarter, of the focal length f.

In other words, the engraving plane 13 is located at a limited distance from the rear face 4 of the window 2, while being located above the object focal plane 12 of the microlenses 5.

For example, the engraving depth 10p is contained in the thickness of the window defined between the engraving plane 13 and the rear face 4.

The plane defined by the intersection of the light beam that passes through the window and the engraving plane 13 defines the size (width) of a sub-pattern of the global image.

The angular size of a sub-pattern of the global image is therefore smaller as the focal length f of the microlenses 5 increases.

As illustrated in FIG. 5, the method according to an embodiment of the invention can thus take place as follows:
The step E01 of providing the transparent window 2 to at least a part of visible light, the front face of the window 3 comprising an array of microlenses 5;
The step E02 of defining a global image comprising at least two patterns, or even 4 patterns, or even 6 or 7 patterns according to the desired visual effect, each pattern being configured to represent an image visible to the observer according to a particular angle of observation through the array of microlenses 5 once engraved;
The step E03 of frosting the rear face to produce a predefined roughness Ra configured to scatter at least a part of visible light;
The step E04 of disposing the global image relative to the array of microlenses;
The step E05 of engraving the global image in the engraving plane 13 of the window 2 through the rear face 4 by laser beam with ultraviolet radiation, incident on the rear face.

The step E02 of defining the global image comprising at least two patterns can be calculated according to a framing or sampling method.

The steps E03 of frosting and E04 of disposing the global image can optionally be interchanged.

FIG. 7 schematically illustrates a cross-sectional view of a device of the prior art.

In this example, as a reference, the engraving plane 13 is disposed between the front face 3 and the object focal plane 12 of the lenses 5. In this exemplary embodiment, a distance d1 between the engraving plane 13 and the rear face 4 of the window 2 is greater than one third of the focal length f1. By definition, the engraving plane 13 is thus considered to be “close” to the front face 3 of the window 2.

The angular size of a sub-pattern of the global image is thus such that when the observer observes a first image according to a first angle of observation, they must vary the angle of observation by several degrees to reach the second angle of observation configured to observe the second image, consecutive to the first.

FIG. 8 illustrates a variation in light intensity observed through the array of microlenses 5 with the device shown schematically in FIG. 7.

To create this figure, an alternation of black and white squares was created as an image in the engraving plane 13 of the window 2, then the intensity received was measured at various angles of observation.

The table below assembles the values that were used to plot the curve of FIG. 8.

| | | | | | | | | | | | | | | | | | |
|---|---|---|---|---|---|---|---|---|---|---|---|---|---|---|---|---|---|
| Degrees | 0 | 1 | 2 | 3 | 4 | 5 | 6 | 7 | 8 | 9 | 10 | 11 | 12 | 13 | 14 | 15 | 16 |
| Movement | 0 | 1.75 | 3.5 | 5.24 | 7 | 8.75 | 10.5 | 12.3 | 14 | 15.8 | 17.6 | 19.4 | 21.3 | 23.1 | 25 | 26.8 | 28.7 |
| [μm] | | | | | | | | | | | | | | | | | |
| % of | 0% | 0% | 0% | 0% | 0% | 25% | 60% | 96% | 100% | 100% | 100% | 100% | 100% | 100% | 100% | 100% | 76% |
| white | | | | | | | | | | | | | | | | | |

| | | | |
|---|---|---|---|
| Black | Gray | White | Gray |

In particular, to perceive that they are beginning to exit the black square, the observer must carry out a variation of the angle of observation of 4° (degrees), and to go from one edge of the white square to the other, they must carry out a variation of the angle of observation of 7°.

Furthermore, by varying the angle of observation to go from a black square to a white square, the observer goes through a phase in which they perceive gray, since they are still partially observing the black square while starting to partially observe the white square.

These effects can give the observer the impression that the passage from a first observable image at a first angle of observation to a second image at a second angle of observation is relatively slow.

FIG. 9 schematically illustrates in a cross-sectional view a device according to an exemplary embodiment of the invention.

In particular, the engraving plane 13 is placed according to the conditions of the invention described above.

In other words, the engraving plane 13 is located between the front face of the window 2 and the object focal plane 12 of the microlenses 5, and is distant from the rear face 4 of the window 2 by a distance d2, where the distance d2 is less than or equal to one third of the focal length f2.

For example, the focal length f2 of the device according to an exemplary embodiment of the invention is greater than the focal length f1 of the device of the prior art.

In this example, the engraving plane 13 is therefore considered to be located relatively close to the rear face 4 of the window 2.

“Close” here means a distance of less than a third, preferably a quarter, of the thickness of the window.

The angular size of a sub-pattern of the global image is thus such that when the observer observes a first image according to a first angle of observation, they must vary the angle of observation by at most 2° to reach the second angle of observation and thus observe the second image, consecutive to the first.

FIG. 10 shows the variation in light intensity observed through the array of microlenses 5 with a device as illustrated in FIG. 9.

To create this figure, like for FIG. 8, an alternation of black and white squares was created in the engraving plane 13 of the window 2, then the intensity received by the observer was measured at various angles of observation.

The table below assembles the values that were used to plot the curve in FIG. 10.

| | | | | | | | | | | | | | |
|---|---|---|---|---|---|---|---|---|---|---|---|---|---|
| Degrees | 0 | 1 | 2 | 3 | 4 | 5 | 6 | 7 | 8 | 9 | 10 | 11 | 12 |
| Movement [μm] | 0 | 12.2 | 24.4 | 36.7 | 49 | 61.2 | 73.6 | 86 | 98.3 | 110.9 | 123.4 | 136 | 148.8 |
| % of white | 0% | 81% | 100% | 0% | 35.71% | 100% | 0% | 0% | 100% | 37% | 0% | 100% | 67% |
| | Black | Gray | White | Black | Gray | White | Black | Black | White | Gray | Black | \|White | Gray |

In particular, to go from the edge of a black square to the edge of a white square, the observer must carry out a variation of the angle of observation of only 1° or 2°, and to go from one edge of a black square to the other, they must carry out a variation of the angle of observation of 1°.

Furthermore, by varying the angle of observation to go from a black square to a white square, the observer can be made to go through a phase in which they perceive gray, since they are still partially observing the black square while starting to partially observe the white square. This transition is faster since it only takes place over an angle variation of 1°.

These effects can give the observer the impression that the passage from a first observable image at a first angle of observation to a second image (consecutive to the first) at a second angle of observation is relatively fast.

The inventors noted that for a variation of angle of observation of 12°, in these exemplary embodiments, a device of the prior art allowed to observe a black square and a white square, while a device according to the invention allows to observe four white squares and four black squares successively.

The security device 1 thus allows to increase the number of images observable through the array of microlenses 5, for the same angular range considered.

For example, for the security device 1 according to an exemplary embodiment of the invention, a period of alternation of the black and white squares is for example 36 μm. This period corresponds to a Nyquist cut-off frequency of 13.89 cycles/mm.

FIG. 6 schematically shows an identity document 100 comprising such a security device 1 according to an exemplary embodiment of the present invention.

Here, the identity document 100 is an identity card, but it could be a passport or a bank card, an identification card (of the access badge type) or a loyalty card, or other.

The identity document 100 comprises a main page comprising for example data relating to the holder of the document.

In the present exemplary embodiment, it comprises the security device 1 which can, for example, comprise a 3D portrait of the holder of the identity document 100.

1. A method for manufacturing a security device including at least a first image visible through an array of microlenses to an observer according to a first angle of observation, and a second image visible through the array of microlenses to the observer according to a second angle of observation, the second angle of observation being different from the first angle of observation, the method comprising:
providing a window that is transparent to at least a part of visible light, the window comprising a front face and a rear face, the front face comprising an array of microlenses, each microlens of the array of microlenses having a focal length defining an object focal plane parallel to the front face and the rear face of the window;
defining a global image comprising at least two patterns configured to represent the first image visible to the observer according to the first angle of observation through the array of microlenses and the second image visible to the observer according to the second angle of observation through the array of microlenses;
disposing the global image relative to the array of microlenses; and
engraving the global image through the rear face and between an engraving plane, defined by an upper tangent plane of the engraved image, and the rear face of the window by a laser beam incident on the rear face, the engraving plane being located between the front face of the window and the object focal plane of the microlenses and being distant from the rear face of the window by a distance that is less than or equal to one third of the focal length, the laser forming an engraving point according to an optical axis, the optical axis forming an angle of incidence with the rear face of the window.

2. The method according to claim 1, wherein the angle of incidence ais between 80° and 100° relative to the rear face of the window.

3. The method according to claim 1, wherein the focal length of the microlenses of the array of microlenses is greater than or equal to 600 μm.

4. The method according to claim 1, wherein the engraving the global image is configured to produce the engraving point having a diameter at most equal to half a width of a sub-pattern of the image.

5. The method according to claim 1, wherein the engraving the global image is configured so that the width of a sub-pattern of the global image corresponds to a difference in angles of observation through the array of microlenses less than or equal to 5°.

6. The method according to claim 1, wherein the disposing the global image relative to the array of microlenses comprises:
disposing a source of lighting on one side of the window and disposing a camera on the same side of the window or on an opposite side of the window;
lighting of the array of microlenses by the source of lighting;
receiving, by the camera, a light beam having interfered with the window;
determining an arrangement of the array of microlenses from the light beam received by the camera; and
redefining the global image with respect to the determined arrangement of the array of microlenses.

7. A security device obtained by the method according to claim 1, the security device comprising:
a window that is transparent to at least a part of visible light, the window (comprising a front face and a rear face, the front face comprising an array of microlenses, each of the microlenses having a focal length defining an object focal plane parallel to the front face and to the rear face of the window; and
a global image, engraved in the window in an engraving plane, defined by an upper tangent plane of the engraved image, the global image comprising at least two patterns configured to form a first image visible to an observer according to a first angle of observation through the array of microlenses and a second image visible to the observer according to a second angle of observation through the array of microlenses, the second angle of observation being different from the first angle of observation, the engraving plane of the global image being located between the front face of the window and the object focal plane of the microlenses and being distant from the rear face of the window by a distance, the distance being less than or equal to one third of the focal length of the microlenses.

8. The device of claim 7, wherein the microlenses of the array of microlenses of the window have a focal length greater than or equal to 600 μm.

9. The device according to claim 7, wherein the array of microlenses of the window has a pitch greater than or equal to 100 μm.

10. An identity document comprising:
the security device according to claim 7, the identity document being one of an identity card, a passport, a bank card, an identification card, and a loyalty card.

11. The method according to claim 2, wherein the angle of incidence is equal to 90°.

12. The method according to claim 5, wherein the engraving the global image is configured so that the width of a sub-pattern of the global image corresponds to a difference in angles of observation through the array of microlenses less than or equal to 2°.

13. The device according to claim 7, wherein the array of microlenses of the window has a pitch less than or equal to 400 μm.

14. The device according to claim 7, wherein the array of microlenses of the window has a pitch greater than or equal to 100 μm, and less than or equal to 400 μm.
